(19) United States
(12) Patent Application Publication
(10) Pub. No.: US 2024/0387850 A1
(43) Pub. Date: Nov. 21, 2024

(54) SYSTEM AND PROCESS FOR ELECTROCHEMICAL FUNCTIONALIZATION OF SUBSTITUTED ANTHRAQUINONES

(71) Applicants: Quino Energy, Inc., Menlo Park, CA (US); Harvard University, Cambridge, MA (US)

(72) Inventors: Eugene S. Beh, Menlo Park, CA (US); Yan Jing, Cambridge, MA (US); Roy Gordon, Cambridge, MA (US)

(21) Appl. No.: 18/663,663

(22) Filed: May 14, 2024

Related U.S. Application Data
(60) Provisional application No. 63/502,395, filed on May 15, 2023.

(51) Int. Cl. H01M 8/18; H01M 4/92

(52) U.S. Cl. CPC H01M 8/188; H01M 4/92

(57) ABSTRACT

The invention relates to synthetic methods for the functionalization of an anthraquinone molecule comprising at least one amino-or carbonyl-substituent. In some aspects of the invention, the synthetic functionalization of the anthraquinone molecule takes place electrochemically within a divided electrolytic cell, e.g., the cell of a redox flow battery.

### CROSS REFERENCE INFORMATION

This application claims benefit from U.S. Provisional Application No. 63/502,395 filed on May 15, 2023.

### STATEMENT REGARDING FEDERALLY SPONSORED RESEARCH

Certain aspects of the present invention were made with government support from the U.S. Department of Energy under award number DE-EE0009795. The government has certain rights to the invention.

### TECHNICAL FIELD

This invention relates generally to a synthetic organic chemistry process. More specifically, the invention relates to the synthetic functionalization of an anthraquinone molecule that is substituted with at least one amine group or at least one carbonyl group.

### BACKGROUND

Redox flow batteries have emerged as a promising large scale energy storage technology. Recently, new classes of redox active species have been explored as starting materials for the redox reactions fundamental to generation of current in a redox flow battery. Useful components of redox flow batteries are known to include 9,10-anthraquinones (hereafter referred to as simply “anthraquinones”) which can be easily reduced to the corresponding 9,10-dihydroxyanthracenes through an electrochemical process such as in a half-cell of a flow battery. See K. Lin, Q. Chen, M. R. Gerhardt, L. Tong, S. B. Kim, L. Eisenach, A. W. Valle, D. Hardee, R. G. Gordon, M. J. Aziz, M. P. Marshak, Science 2015, 349, 1529-1532. For instance, in WO 2022/271456, a novel approach to employ a Marshalk reaction via an anthraquinone derivative in a new application of a redox flow battery was identified, resulting in improved efficiency in the redox process and overall efficiency improvement in the redox flow battery.

Novel redox chemistries are therefore desirable to improve efficiencies of redox flow batteries. It is desirable, in general, for synthetic chemistry processes to be atom economical and minimize waste. The present invention is directed generally to new anthroquinone derivatives that may undergo reductive amination giving rise to more efficient, and more accessible starting materials for carrying out the redox chemistry within a redox flow battery. More specifically, anthraquinone derivatives disclosed herein are well-suited for use as the anolyte starting in a redox flow batteries as a species to be reduced, beneficially allowing lower reagent costs and efficient generation of electrons.

### BRIEF DESCRIPTION OF THE DRAWINGS

FIG. 1 depicts a reaction scheme for reductive amination of an amine-substituted anthraquinone.

FIG. 2 depicts a reaction scheme for reductive amination of a carbonyl-substituted anthraquinone.

FIG. 3 depicts an electrolytic cell for effecting the reductive amination of anthraquinones in accordance with embodiments disclosed herein.

FIG. 4 depicts the ¹H NMR spectrum of the reaction product from Example 1.

### DETAILED DESCRIPTION

Disclosed herein are systems and processes for electrochemical functionalization of substituted anthraquinones. Generally, the processes and systems disclosed herein operate on a principle of reductive amination. Reductive amination is a process in synthetic organic chemistry that classically combines an amine with a ketone or aldehyde in the presence of a reducing agent that converts the imine condensation intermediate into an amine. The net result is the replacement of the carbonyl group with an amine functional group. Typical reducing agents include sodium borohydride, sodium cyanoborohydride, sodium triacetoxyborohydride, and so on. Reduction also may be achieved by hydrogenation with hydrogen gas over supported metal catalysts. See, e.g. O. I. Afanasyev, E. Kuchuk, D. L. Usanov, D. Chusov, Chemical Reviews, 2019, 119, 11857-11911.

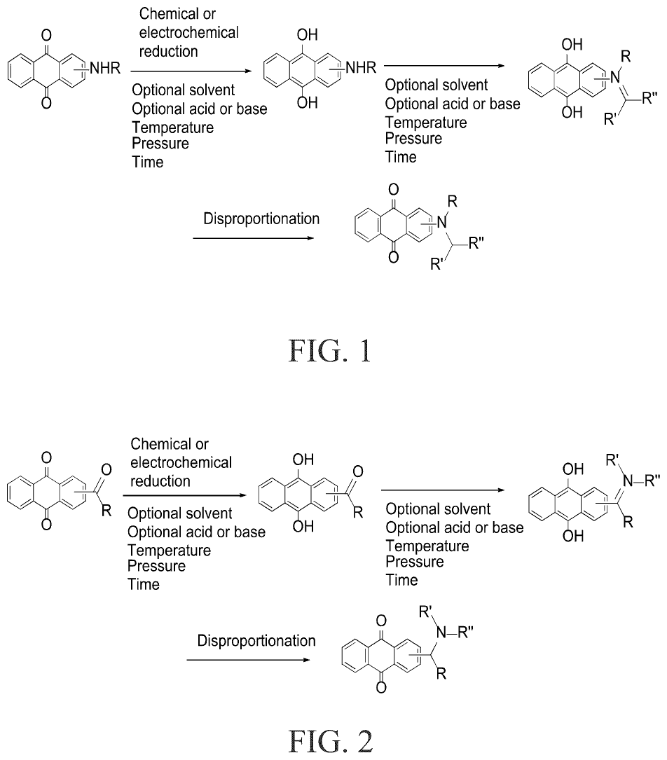

Processes disclosed herein may proceed either by reaction of an amine-substituted anthraquinone with a carbonyl reagent or reaction of a carbonyl-substituted anthraquinone with an amino reagent. FIG. 1 and FIG. 2 are representative of each of these pathways, respectively.

Looking first to the pathway summarized by FIG. 1, an amine-substituted anthraquinone starting material can be reduced to the amine-substituted dihydroxyanthracene, in the presence of an optional acid or base, and an optional solvent. In a next step, the reduced amine-substituted 9,10-dihydroxyanthracene can react with a ketone or aldehyde to form an imine or iminium intermediate. The imine or iminium intermediate then may undergo disproportionation, in which the dihydroxyanthracene portion of the molecule becomes oxidized to the corresponding anthraquinone as the imine or iminium substituent is reduced to the corresponding amine.

An alternate aspect of the invention, summarized in FIG. 2, can proceed from a carbonyl-substituted anthraquinone starting material, e.g., an anthraquinone substituted with a ketone or aldehyde (hereafter referred to as a “carbonyl group” or a “carbonyl substituent”). As shown, the carbonyl substituent can first be reduced to the carbonyl-substituted dihydroxyanthracene, in the presence of an optional acid or base, and an optional solvent. The reduced carbonyl-substituted 9,10-dihydroxyanthracene then can react with an amine to form an imine or iminium intermediate. The imine or iminium intermediate then may undergo disproportionation, in which, as above, the dihydroxyanthracene part of the molecule becomes oxidized to the anthraquinone as the imine or iminium is reduced to the amine.

As will be clear to those of skill in the art, the reaction pathways demonstrated demonstrate a novel utility for amine-and carbonyl-substituted anthroquinones. Thus, in certain aspects, processes disclosed herein can comprise application of a conventional redox process using anthroquinones of Formula I or II as anolytes.

In both aspects of the invention, the anthraquinone starting material may be substituted with one amine or carbonyl group, more than one amine or carbonyl group, or a combination of amine and carbonyl groups. Each amine or carbonyl group would be able to react independently as depicted in FIG. 1 and FIG. 2.

The initial reduction of the anthraquinone starting material can be achieved chemically by adding a reducing agent such as sodium dithionite, through hydrogenation with hydrogen gas and an optional additional catalyst, or electrochemically by exposing it to an electrode that is maintained at a sufficiently low reduction potential by means of an external power supply. Depending on the total number of amine or carbonyl groups on the anthraquinone starting material, increased molar equivalents of reducing agent, hydrogen gas, or electrons can be used.

The reaction may be heated, cooled, or held at different temperatures throughout the duration of the reaction. After a further predetermined amount of time, or after a predetermined amount of charge has been passed, the reaction product is isolated from the reaction mixture and optionally purified through conventional means familiar to one skilled in the art, such as precipitation, filtration, distillation, sublimation, recrystallization, solvent extraction, washing, chromatography, centrifugation, and so on.

In some embodiments of the invention, the anthraquinone starting material comprises of amine-substituted compounds of Formula I or Formula II:

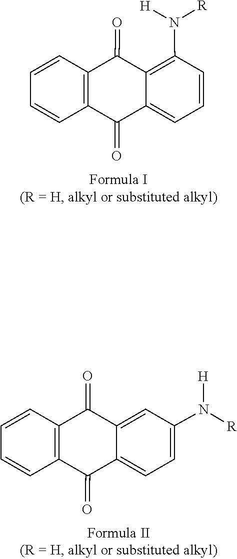

wherein R is selected from the group comprising of: hydrogen, alkyl, or alkyl substituted with water-solubilizing functional groups such as phosphonic acid, carboxylic acid, sulfonic acid, hydroxyl, oligo (ethylene glycol), tertiary amino, and so on.

In other embodiments of the invention, the anthraquinone starting material comprises of carbonyl-substituted compounds of Formula III or Formula IV:

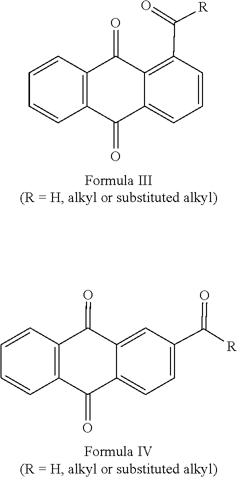

wherein R is selected from the group comprising of: hydrogen, alkyl, or alkyl substituted with water-solubilizing functional groups such as phosphonic acid, carboxylic acid, sulfonic acid, hydroxyl, oligo (ethylene glycol), tertiary amino, and so on.

In other embodiments of the invention, the anthraquinone starting material comprises of compounds of Formula V:

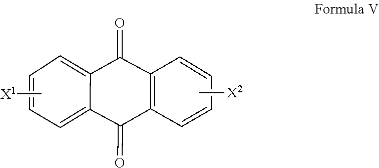

wherein one or both of X¹ and X² is independently an amino substituent or a carbonyl substituent as defined with respect to Formula I-IV above, and X¹ is covalently attached to the anthraquinone core at the 1-, 2-, 3-, or 4-position, and X² is covalently attached to the anthraquinone core at the 5-, 6-, 7-, or 8-position. It will be appreciated by one skilled in the art that additional substituents can be present on the anthraquinone of Formula V, and may change the position numbering of the aforementioned amine or carbonyl group. Generally, the position of X¹ and X² is not expected to have a significant effect on the general reactivity of the substituted anthraquinone.

In some embodiments of the invention, the anthraquinone starting material comprises an amine group directly attached to the anthraquinone core, and a carbonyl group that is part of the same molecule but is not directly attached to the anthraquinone core. In further embodiments of the invention, the carbonyl group is covalently attached to the anthraquinone core by means of an alkyl or substituted alkyl linker, and the reaction proceeds intramolecularly, or under certain conditions, could proceed to form dimers, or cyclamers, or oligomeric or polymeric chains.

In some embodiments of the invention, the anthraquinone starting material comprises a carbonyl group directly attached to the anthraquinone core, and an amine group that is part of the same molecule but is not directly attached to the anthraquinone core. In further embodiments of the invention, the amine group is attached to the anthraquinone core by means of an alkyl or substituted alkyl linker, and the reaction proceeds intramolecularly, or under certain conditions, could proceed to form dimers, or cyclamers, or oligomeric or polymeric chains.

In some embodiments of the invention, the optional base is an inorganic hydroxide, a metal alkoxide, a metal carboxylate, an amine, or an amidine. In particular embodiments of the invention, the optional base is an alkali metal hydroxide such as sodium hydroxide or potassium hydroxide. In other embodiments of the invention, the metal carboxylate is an alkali metal carboxylate such as sodium acetate, sodium formate, or potassium acetate. In other embodiments of the invention, the metal alkoxide is an alkali metal alkoxide such as sodium methoxide or potassium tert-butoxide. In other embodiments of the invention, the amine is a trialkylamine such as triethylamine or diisopropylethylamine which only serves to function as a base. In still other embodiments, the amine serves as a base and also as the reactant (depicted as the R′NHR″ in FIG. 2). In other embodiments, the amidine is a non-nucleophilic base such as 1,8-diazabicycloundec-7-ene (DBU) or 1,5-diazabicyclo [4.3.0] non-5-ene (DBN).

In some embodiments of the invention, the optional acid comprises a mineral acid, a sulfonic acid, a phosphonic acid, a carboxylic acid, protonated ammonium, or combinations thereof. In particular embodiments of the invention, the mineral acid is an inorganic acid such as hydrochloric acid, phosphoric acid, or sulfuric acid. In other embodiments of the invention, the sulfonic acid comprises methylsulfonic acid, trifluoromethanesulfonic acid, para-toluenesulfonic acid, or taurine. In other embodiments of the invention, the phosphonic acid comprises methylphosphonic acid, ethylphosphonic acid, or benzylphosphonic acid. In other embodiments of the invention, the carboxylic acid comprises formic acid, acetic acid, propionic acid, or benzoic acid. In still other embodiments of the invention, the protonated ammonium species comprises ammonium salts, methylammonium salts, benzylammonium salts, alkylammonium salts, dialkylammonium salts, or trialkylammonium salts.

In general, most ketones or aldehydes can undergo the reaction with an amine-substituted anthraquinone starting material, analogously to the traditional reductive amination described in the literature above. In some embodiments of the reaction, the ketone or aldehyde is a water-soluble molecule such as formaldehyde, acetaldehyde, or acetone. In other embodiments of the reaction, the ketone or aldehyde is an organic compound such as benzaldehyde or acetophenone that is only sparingly soluble or insoluble in water but is soluble in organic solvents. In still more embodiments of the invention, the ketone or aldehyde, such as glyoxylic acid, contains one or more additional functional groups that imparts water solubility under certain conditions. These groups include phosphonic acid, carboxylic acid, sulfonic acid, hydroxyl, oligo (ethylene glycol), tertiary amino, and so on.

In some embodiments of the invention, the ketone or aldehyde can reversibly interconvert between a form that has a free carbonyl group and a form in which a molecule of water or alcohol has been added to the carbonyl group thus forming a gem-diol, a hemiacetal, or a hemiketal. In further aspects of the invention, the alcohol group is located on the same molecule as the carbonyl group and the reversible addition takes place intramolecularly. In other aspects of the invention, the carbonyl functional group forms upon ring opening to an open chain form during the course of the reaction. Examples of such “transient” ketones or aldehydes are sugars including but not limited to glucose, galactose, fructose, mannose, xylose, arabinose, glyceraldehyde, lactose, cellobiose, and maltose. These sugars can exist as either the D-or the L-enantiomer, or a mixture of the two, or a racemic mixture. It will be appreciated by one skilled in the art that any sugar may be used in the embodiments described herein.

In general, most primary or secondary amines, or ammonia, can undergo the reaction with a carbonyl-substituted anthraquinone starting material, analogously to the traditional reductive amination described in the literature above. In some embodiments of the reaction, the amine is a water-soluble molecule such as ammonia, methylamine, dimethylamine, cyclohexylamine, and so on. In other embodiments of the reaction, the amine is an organic compound such as octylamine that is only sparingly soluble or insoluble in water but is soluble in organic solvents. In still more embodiments of the invention, the amine, such as iminodiacetic acid, contains one or more additional functional groups that imparts water solubility under certain conditions. These groups include phosphonic acid, carboxylic acid, sulfonic acid, hydroxyl, oligo(ethylene glycol), tertiary amino, and so on.

In certain embodiments of the invention, the base, the carbonyl compound (depicted as R′(C═O)R″ in FIG. 1), the amine (depicted as R′NHR″ in FIG. 2), or any combination of the foregoing, acts as the solvent and in effect the system can be “solvent-free.” In other embodiments of the invention, the system can comprise any suitable solvent, for instance, the solvent may be a polar solvent that is either protic or aprotic, and mixtures thereof, may be used in the embodiments described herein.

In certain aspects, the solvent is selected from the group consisting of water, methanol, ethanol, isopropanol, 1,4-dioxane, N,N-dimethylformamide, and combinations thereof. In other embodiments of the invention, the solvent can comprise more than one solvent, such as water and ethanol, methanol and N,N-dimethylformamide, water and 1,4-dioxane, and so on. It will be appreciated by one skilled in the art that any

In some embodiments of the invention, the electrochemical process for reduction of the anthraquinone starting material is augmented by employing a combination of chemical or hydrogenation methods for a sub-stoichiometric molar amount of the anthraquinone starting material.

In some embodiments of the invention, wherein the anthraquinone starting material is at least partly reduced by means of hydrogenation, the optional additional catalyst is a catalyst for catalytic hydrogenation, or a pre-catalyst that is converted to the active catalyst for catalytic hydrogenation during the course of the reaction. The catalyst may be optionally supported on a substrate. Examples of catalysts include, but are not limited to, nickel on carbon, palladium on carbon, platinum on carbon, rhodium on carbon, palladium hydroxide, platinum black, platinum dioxide, Wilkinson's catalyst, Crabtree's catalyst, Shvo's catalyst, and so on.

In some embodiments of the invention, the catalyst is Raney Nickel and the hydrogen is already present on the surface of the catalyst, and not provided as a gas to the atmosphere of the reaction vessel.

In some embodiments of the invention, the reaction atmosphere is partially or wholly comprised of inert gas such as nitrogen or argon. The reaction atmosphere can be at atmospheric pressure, lower than atmospheric pressure, or above atmospheric pressure.

In some embodiments of the invention, the reaction atmosphere is partially or wholly comprised of hydrogen. The reaction atmosphere can be at atmospheric pressure, lower than atmospheric pressure, or above atmospheric pressure.

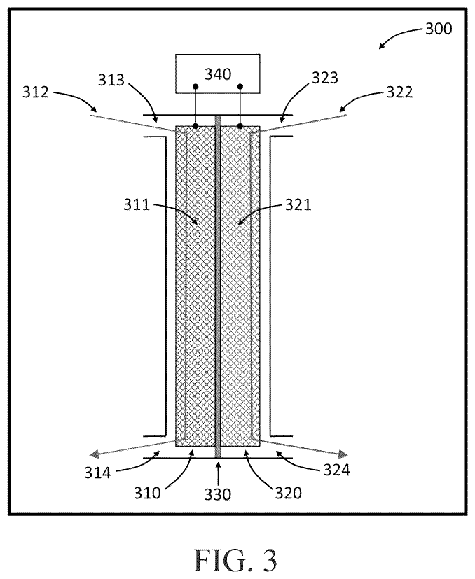

In some embodiments of the invention, summarized as a chemical reaction in FIG. 1 and FIG. 2, and depicted in FIG. 3, reduction of the anthraquinone starting material takes place electrochemically through the use of a divided electrolytic cell 300. The divided electrolytic cell 300 comprises a first chamber 310 with a first electrode 311, and is separated from a second chamber 320 with a second electrode 321 by an ion-conducting membrane 330. There may independently be an electrocatalyst on the first electrode 311 only, an electrocatalyst on the second electrode 321 only, both the first and second electrodes 311, 321, or there can be no electrocatalyst on either the first or second electrode 311, 321.

A first fluid stream 312 comprising a comprising an anthraquinone starting material, a ketone or aldehyde if the anthraquinone starting material is substituted with one or more amine groups, an amine if the anthraquinone starting material is substituted with one or more carbonyl groups, an optional acid or base, and an optional solvent is flowed through a first chamber inlet 313 into the first chamber of the electrolytic cell 310 such that the first fluid stream makes contact with the first electrode 311 and exits through a first chamber outlet 314. At the same time, a second fluid stream 322 is flowed through a second chamber inlet 323 into the second chamber of the electrolytic cell 320 such that the second fluid stream makes contact with the second electrode 321 and exits through a second chamber outlet 324. An electric potential 340 is applied to the two electrodes such that the first electrode is at a more negative potential relative to the second electrode. (In other words, the first electrode is the cathode and the second electrode is the anode.)

As the first fluid stream 312 passes the first electrode 311, it is electrochemically reduced. Likewise, as the second fluid stream 322 passes the second electrode 321, it is electrochemically oxidized. The first fluid stream 312 may make just one pass through the first chamber 310 of the divided electrolytic cell 300, or the fluid exiting the first chamber outlet 314 may be recirculated and flowed back into the first chamber inlet 313 multiple times. Likewise, the second fluid stream 322 may make just one pass through the second chamber 320 of the divided electrolytic cell 300, or the fluid exiting the second chamber outlet 324 may be recirculated and flowed back into the second chamber inlet 323 multiple times. The divided electrolytic cell 300, first fluid stream 312, and/or second fluid stream 322 may be heated, cooled, or held at different temperatures throughout the duration of the reaction.

After a predetermined amount of time, or after a predetermined amount of charge has been passed, the reaction product may be subsequently isolated from the first fluid stream 312 and optionally purified through conventional means familiar to one skilled in the art. The threshold amount of charge to be passed may be pre-determined by examining the theoretical amount of charge required for the reaction to proceed to completion. In FIG. 1 and FIG. 2, the anthraquinone starting material requires two equivalents of electrons to be reduced to the 9,10-dihydroxyanthracene derivative which then reacts with the amine, ketone, or aldehyde, to form the imine or iminium intermediate. This intermediate then undergoes intramolecular disproportionation to produce the reductively aminated product and a re-oxidized anthraquinone core, which can accept two more electrons. In this case, the threshold amount of charge is 4 equivalents with respect to the amount of anthraquinone starting material originally present. In the case where two equivalents of amine, ketone, or aldehyde react with one molecule of anthraquinone starting material, the theoretical amount of charge to be passed would be 6 equivalents. Greater threshold amounts of charge can be set to account for process inefficiencies such as the effect of oxygen reoxidizing the reaction mixture, Coulombic efficiencies arising from side reactions and so on.

Alternatively, a threshold voltage (if current is passed galvanostatically) or a threshold current or current density (if current is passed potentiostatically) could be used in place of the predetermined amount of time or charge passed. Towards the end of the reaction, there remain fewer and fewer anthraquinone cores in the reaction mixture that are available to accept electrons. This manifests as a sharp increase in the voltage if current is passed galvanostatically, or a decrease in the current if current is passed potentiostatically. It is advisable to set a threshold upper voltage or a threshold lower current (or current density), beyond which current flow is stopped, in order to minimize the amount of potential side reactions. The threshold voltage can be defined as a fixed number, for example, >0.5 V/cell, >1.0 V/cell, >1.5 V/cell, >1.6 V/cell, >1.7 V/cell, >1.8 V/cell, >1.9 V/cell, >2.0 V/cell, >2.1 V/cell, >2.2 V/cell, >2.3 V/cell, >2.4 V/cell, >2.5 V/cell, and so on, or it could be defined as a percentage increase over the average voltage in the first of a certain number of equivalents of charge passed, such as >10% over the average voltage during the first equivalent of charge passed, >20% over the average voltage during the first 0.5 equivalents of charge passed, >30% over the average voltage during the first 0.5 equivalents of charge passed, >40% over the average voltage during the first 0.25 equivalents of charge passed, >50% over the average voltage during the first 0.1 equivalents of charge passed, and many such combinations thereof. For example, in the case where the theoretical amount of charge that can be passed is 4 equivalents, and the cell voltage is an average of 1.5 V over the first equivalent of charge passed, a threshold voltage that is >30% over the starting voltage means the current would be stopped once the voltage exceeds 1.95 V/cell, when the current is being applied galvanostatically. Similarly, the threshold current (or current density) can be defined as a number, such as <10 A, <1 A, <0.1 A, <0.01 A, <10 mA/cm², <1 mA/cm², <0.1 mA/cm², <0.01 A/cm², and so on, or it could be defined as a percentage of the average current or current density in the first of a certain number of equivalents of charge passed, such as <10% of the average current or current density during the first equivalent of charge passed, <5% of the average current or current density during the first 0.5 equivalents of charge passed, <2% of the average current or current density during the first 0.5 equivalents of charge passed, <1% of the average current or current density during the first 0.2 equivalents of charge passed, <0.5% of the average current or current density during the first 0.25 equivalents of charge passed, <0.2% of the average current or current density during the first 0.1 equivalents of charge passed, <0.1% of the average current or current density during the first 0.1 equivalents of charge passed, and many such combinations thereof. For example, in the case where the theoretical amount of charge that can be passed is 4 equivalents, and the current density is an average of 100 mA/cm² over the first equivalent of charge passed, a threshold current density of <1% of the starting current density means the current would be stopped once the current density drops below 1 mA/cm², when the current is being applied potentiostatically. In some embodiments, current is passed galvanostatically until the cell voltage hits some threshold value, such as 1.2V, 1.4V, 1.6V, 1.8V and so on, and then the cell voltage is maintained until the current or current density drops below a threshold value as similarly specified for potentiostatic operation.

In some embodiments of the invention, the first and second electrodes 311, 321 may comprise defined flow channels to direct fluid.

In some embodiments of the invention, the first and second electrodes 311, 321 are conductive carbon electrodes. In other embodiments of the invention, the first electrode 311 is a conductive carbon electrode and the second electrode 321 comprises nickel, cobalt, iron, stainless steel, or platinum.

In some embodiments of the invention, the ion-selective membrane 330 is a cation-conducting membrane such as Nafion® 212, FuMATech® E-630, or Selemion CMV-NR.

In some embodiments of the invention, the second fluid stream 322 comprises hydrogen gas. In further embodiments of the invention, the second electrode 321 is also a gas diffusion electrode. In still further embodiments of the invention, the second electrode 321 also contains a good electrocatalyst for hydrogen oxidation such as platinum.

In some embodiments of the invention, the second fluid stream 322 comprises methanol. In further embodiments of the invention, the second electrode 321 also contains a good electrocatalyst for methanol oxidation such as platinum-ruthenium.

In some embodiments of the invention, the second fluid stream 322 comprises an aqueous solution of a salt of ferrocyanide, such as sodium ferrocyanide, potassium ferrocyanide, or ammonium ferrocyanide.

In some embodiments of the invention, the second fluid stream 322 comprises an aqueous solution of an alkali metal hydroxide such as sodium hydroxide or potassium hydroxide. In further embodiments of the invention, the second electrode 321 comprises a typical alkaline electrolyzer material such as nickel or stainless steel.

In some embodiments of the invention, the ketone or aldehyde or amine, as appropriate, is not included in the first fluid stream 312, but is only added later to the first fluid stream 312 after the current density in the divided electrolytic cell 300 has fallen below a threshold value. In further embodiments of the invention, the electric potential 340 between the first and second electrodes 311, 321 is switched to open circuit potential after (a) the current density in the divided electrolytic cell 300 has fallen below a threshold value, (b) after the applied electric potential rises above a threshold value, or (c) after a predetermined amount of charge has been passed, and before the aldehyde is added to the first fluid stream 312.

In some embodiments of the invention, the divided electrolytic cell 300 can be used as a redox flow battery cell without having to change out the first or second electrodes 311, 321, or the ion-conducting membrane 330. In further embodiments of the invention, the reductive amination product that is produced in the first fluid stream 312 using the divided electrolytic cell 300 is not drained from the first chamber 310 of the divided electrolytic cell 300 but is retained in the solution phase and used directly as the negative electrolyte (i.e., the negolyte or anolyte) of a redox flow battery wherein the divided electrolytic cell 300 is the redox flow battery cell. In still further embodiments of the invention, the second fluid stream 322 is not drained from the second chamber 320 of the divided electrolytic cell 300 but is retained in the solution phase and used directly as the positive electrolyte (i.e. the posolyte or catholyte) of a redox flow battery wherein the divided electrolytic cell 300 is the redox flow battery cell. In further embodiments of the invention, both the first and second fluid streams 312, 322 are not drained from the first and second chambers 310, 320 respectively of the divided electrolytic cell 300 but are retained in the solution phase and used directly as the negative and positive electrolytes respectively of a redox flow battery, or as the positive and negative electrolytes respectively of a redox flow battery, wherein the divided electrolytic cell 300 is the redox flow battery cell.

In further embodiments of the invention, the state of charge of the negative and positive electrolytes (formerly the first fluid stream 312 and second fluid stream 322, or, in some other embodiments, the second fluid stream 312 and the first fluid stream 322) can be individually adjusted, or rebalanced, to maximize the capacity of the resulting redox flow battery. For example, the first or second fluid stream 312, 322 can be treated with an oxidant such as oxygen in atmospheric air, hydrogen peroxide, ozone, sodium hypochlorite, and so on, or the first or second fluid stream 312, 322 can be treated with a reducing agent such as hydrogen together with an optional catalyst, hydrazine, hydrazine hydrate, sodium thiosulfate, sodium dithionite, sodium sulfite, and so on.

Unless otherwise indicated, all numbers expressing feature sizes, amounts, volumes, areas, concentration, times, temperatures, and other chemical and physical properties used in the specification and claims are to be understood as being modified in all instances by the terms “about”, “approximately”, “around”, and similar terms. Accordingly, unless indicated to the contrary, the numerical parameters set forth in the foregoing specification and attached claims are approximations that can vary depending on the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5; <10% includes 10%, 9.8%, 5.5%, 2%, 0.01%, and 0%; >90% includes 90%, 90.2%, 94.5%, 98%, 99.99%, and 100%) and any range within that range.

The foregoing description has been presented for the purposes of illustration and description. It is not intended to be exhaustive or to limit the embodiments to the precise form disclosed. Many modifications and variations are possible in light of the above teachings. Any or all features of the disclosed embodiments can be applied individually or in any combination and are not meant to be limiting, but purely illustrative. It is intended that the scope of the invention be limited not with this detailed description, but rather, determined by the claims appended hereto.

### EXAMPLES

### Example 1

1,5-diaminoanthraquinone (1,5-DAAQ, technical grade, 85%), NaOH (45% in water), KOH (50% in water), sodium hydrosulfite (technical grade, 82.5%, also known as sodium dithionite), glyoxylic acid (50% in water) sodium ferrocyanide decahydrate, and potassium ferrocyanide trihydrate were obtained from Sigma-Aldrich.

A solution of 1,5-diamino-9,10-dihydroxyanthracene was produced by first sparging a mixture of 50 mL of 1.5 M NaOH and 50 mL of 1.5 M KOH with nitrogen for 10 minutes. Then, 2.382 g of 1,5-DAAQ (10 mmol) and 2.110 g of sodium hydrosulfite (10 mmol wrt. 82.5% purity) were added and the mixture stirred for 30 minutes under nitrogen. This step was needed because of the poor solubility of 1,5-DAAQ in aqueous base but could be replaced by other methods for improving the solubility of raw materials (as disclosed in the commonly owned application submitted on the same day herewith, entitled “Improved Production of Reaction Products from an Electrosynthetic Reaction”). Next, an electrochemical cell with a geometric electrode area of 50 cm² was constructed using cell hardware purchased from Fuel Cell Technologies, with pyrosealed graphite flow plates, AvCarb EP40 pre-activated carbon paper electrodes, EPDM gaskets, and a FuMATech E-620 (K) cation exchange membrane. Note that the electrochemical cell is being used as an electrolyzer here, so the anode is the positive terminal and the cathode is the negative terminal. The anolyte reservoir was charged with 500 mL of aqueous solution comprising 0.3 mol/L of sodium ferrocyanide, 0.3 mol/L of potassium ferrocyanide, 0.5 mol/L of NaOH, and 0.5 mol/L of KOH. The catholyte reservoir was charged with the solution of 1,5-diamino-9,10-dihydroxyanthracene prepared earlier. Both anolyte and catholyte reservoirs were kept under nitrogen.

The pumps to the electrochemical cell were started (peristaltic pumps, ˜50 mL/min flow rate) and the catholyte and anolyte were heated to 50° C. A syringe pump was used to add 2.32 mL of 50% glyoxylic acid (21 mmol) to the catholyte reservoir over the course of 15 minutes, and at the same time, electrical current was passed galvanostatically at a current density of 50 mA/cm² until 4 molar equivalents of electrons per mole of quinone present were passed, as indicated by a sharp rise in the cell voltage above ˜1.6V. Once this threshold was reached, the electrical current was shut off and the reaction circulated at 50° C. overnight.

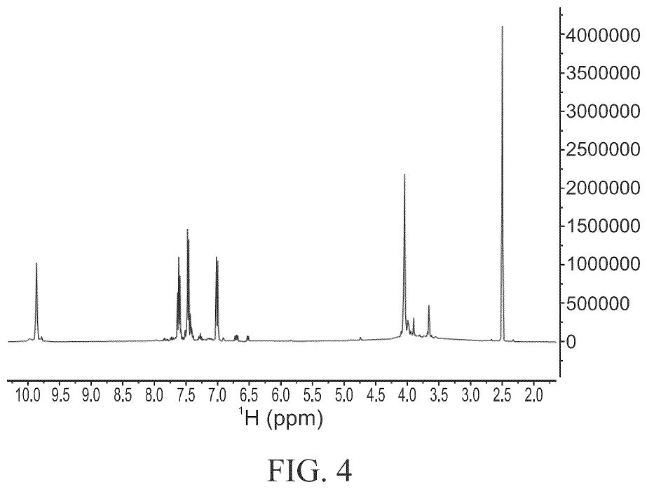

The catholyte was drained, exposed to air, and acidified to pH ˜3 using dilute hydrochloric acid, causing a fine solid precipitate to form. The precipitate was collected by vacuum filtration and rinsed with deionized water, then dried in air at room temperature to give the product 1,5-bis (carboxymethylamino) anthraquinone. NMR (FIG. 4) confirmed the product identity. Yield: 1.98 g (55.9%)

What is claimed is:

1. A system for reductive amination of an anthraquinone derivative of Formula I, Formula II, Formula III, Formula IV, or Formula V, comprising a divided electrolytic cell, the divided electrolytic cell comprising:
a first chamber with a first electrode, configured to accept and have an electrochemical reaction with a first fluid stream comprising said anthraquinone derivative, a ketone or aldehyde or amine, as appropriate, an optional acid or base, and an optional solvent;
a second chamber with a second electrode, configured to accept and have an electrochemical reaction with a second fluid stream;
the first chamber and first electrode separated by an ion-conducting membrane from the second chamber and second electrode.

2. The system of claim 1, wherein the first fluid stream is configured to be recirculated to the first chamber and the second fluid stream is configured to be recirculated to the second chamber.

3. The system of claim 1, wherein at least one of the first electrode and second electrode comprise an electrocatalyst or electrocatalyst precursor.

4. The system of claim 1, further comprising an electrical power supply configured to apply an electrical potential between the first electrode and the second electrode.

5. The system of claim 1, wherein the optional base in the first fluid stream comprises an inorganic hydroxide, a metal alkoxide, an amine, an amidine, or combinations thereof.

6. The system of claim 5, wherein the base is selected from the group comprising of:
sodium hydroxide, potassium hydroxide, or mixtures thereof.

7. The system of claim 1, wherein the optional acid in the first fluid stream comprises a mineral acid, a sulfonic acid, a phosphonic acid, a carboxylic acid, protonated ammonium, or combinations thereof.

8. The system of claim 1, wherein the solvent is water.

9. The system of claim 1, wherein the ion-conducting membrane is a cation exchange membrane.

10. The system of claim 6, wherein:
the ion-conducting membrane is a cation exchange membrane;
the second fluid stream comprises an aqueous solution of sodium hydroxide, potassium hydroxide, or combinations thereof;
the second electrode comprises nickel, cobalt, iron, stainless steel, platinum, or combinations thereof; and
the solvent comprises water.

11. The system of claim 6, wherein:
the ion-conducting membrane is a cation exchange membrane;
the second fluid stream comprises hydrogen gas;
the second electrode is configured to allow hydrogen to be oxidized and thereby act as a source of electrons; and
the solvent comprises water.

12. The system of claim 11, wherein the second electrode further comprises an electrocatalyst comprising of platinum.

13. The system of claim 6, wherein:
the ion-conducting membrane is a cation exchange membrane;
the second fluid stream comprises methanol; and
the solvent comprises water.

14. The system of claim 13, wherein the second electrode further comprises an electrocatalyst comprising of platinum-ruthenium.

15. A redox flow battery configured to utilize a first flow battery reactant and a second flow battery reactant to store and release electrical energy, where the redox flow battery is additionally capable of performing reductive amination of an anthraquinone derivative of Formula I, Formula II, Formula III, Formula IV, or Formula V, comprising a divided electrolytic cell, the divided electrolytic cell comprising:
a first chamber with a first electrode, configured to accept and have an electrochemical reaction with a first fluid stream comprising said anthraquinone derivative, a ketone or aldehyde or amine, as appropriate, an optional acid or base, and an optional solvent;
a second chamber with a second electrode, configured to accept and have an electrochemical reaction with a second fluid stream;
wherein:
the first chamber and first electrode separated by an ion-conducting membrane from the second chamber and second electrode;
the divided electrolytic cell additionally comprises a redox flow battery that utilizes the anthraquinone derivative that has been reductively aminated and remains in the first stream as the first flow battery reactant, and the second fluid stream as the second flow battery reactant.

16. The system of claim 15, wherein:
the ion-conducting membrane is a cation exchange membrane;
the first and second fluid streams comprise an aqueous solution selected from the group comprising of sodium hydroxide, potassium hydroxide, or mixtures thereof; wherein
the first and second electrodes are selected from the group comprising of graphite, carbon black, carbon felt, carbon cloth, carbon paper, carbon nanotubes, other forms of conductive carbon, or mixtures thereof;
and wherein the system further comprises of a solvent comprising of water.

17. The system of claim 16, wherein the second fluid stream additionally comprises sodium ferrocyanide, sodium ferricyanide, potassium ferrocyanide, potassium ferricyanide, or combinations thereof.

18. A method for reductive amination of an anthraquinone derivative comprising:
providing a divided electrolytic cell comprising:
a first chamber with a first electrode, configured to accept and have an electrochemical reaction with a first fluid stream comprising said anthraquinone derivative, a ketone or aldehyde or amine, as appropriate, an optional acid or base, and an optional solvent;
a second chamber with a second electrode, configured to accept and have an electrochemical reaction with a second fluid stream;
wherein the first chamber and first electrode separated by an ion-conducting membrane from the second chamber and second electrode;
flowing the first fluid stream through the first chamber and contacting the first electrode;
flowing the second fluid stream through the second chamber and contacting the second electrode; and
applying an electrical potential between the first and second electrode, so as to cause an electrochemical reduction reaction in the first fluid stream and an electrochemical oxidation reaction in the second fluid stream;
wherein the anthraquinone derivative has Formula V: 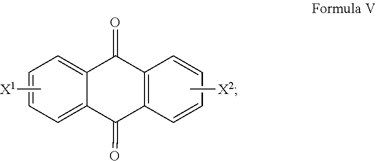
X¹ and X² are each independently H, an amino substituent, or a carbonyl substituent; and
X¹ and X² are not both H.

19. The method of claim 18, wherein the first fluid stream is configured to recirculate back to the first chamber with the first electrode, or the second fluid stream is configured to recirculate back to the second chamber with the second electrode, or the first fluid stream is configured to recirculate back to the first chamber with the first electrode and the second fluid stream is configured to recirculate back to the second chamber with the second electrode.

20. The method of claim 18, further comprising:
waiting until a threshold amount of time or charge has passed, or until the current density has dropped below a threshold value, or after the applied electric potential rises above a threshold value;
draining the first fluid stream from the first chamber; and
isolating the product from the reaction mixture obtained from the drained first fluid stream.
